(19) United States
(12) Patent Application Publication
(10) Pub. No.: US 2026/0061789 A1
(43) Pub. Date: Mar. 5, 2026

(54) TRAILER HITCH SENSOR ASSEMBLY AND METHODS OF USING THE SAME

(71) Applicant: Lightship Energy, Inc., Broomfield, CO (US)

(72) Inventors: Neal LAWRENCE, San Francisco, CA (US); Jami ROSE, San Francisco, CA (US); Nicholas Hayden HERRON, Pacifica, CA (US); Craig FEDOR, Redwood City, CA (US); Josh HEIMANN, Crestwood, KY (US)

(73) Assignee: Lightship Energy, Inc., Broomfield, CO (US)

(21) Appl. No.: 19/318,859

(22) Filed: Sep. 4, 2025

Related U.S. Application Data
(60) Provisional application No. 63/691,309, filed on Sep. 5, 2024.

(51) Int. Cl. B60D 1/24

(52) U.S. Cl. CPC B60D 1/248

(57) ABSTRACT

An apparatus includes a coupler, a bracket, and a sensor. The coupler is configured to couple to a hitch of a tow vehicle. The bracket is configured to couple to a body of the trailer. The sensor is disposed at an interface of the coupler and the bracket and is configured to measure an axial force and a vertical force at the interface. A method of using the apparatus includes receiving load data from the sensor. Based on the load data, a vertical load and an axial load associated with the tow vehicle towing the trailer is determined. A motion system of the trailer is operated based on at least one of the vertical load or the axial load.

### CROSS-REFERENCE TO RELATED APPLICATIONS

This application claims priority to and the benefit of U.S. Provisional Application No. 63/691,309, filed Sep. 5, 2024, entitled “Trailer Hitch Sensor Assembly and Methods of Using Thereof,” the disclosure of which is incorporated herein by reference in its entirety.

### BACKGROUND

The present application relates generally to trailers and trailer hitches, and more particularly, to sensor assemblies for trailer hitches.

Trailer hitches allow for the towing of various loads such as utility trailers and recreational vehicles. Managing loads associated with trailers can be critical to ensuring trailer hauling safety. Trailer loads can include the weight of the trailer (e.g., vertical loads), loads associated with acceleration and braking during operation (e.g., axial loads), and moments associated with such loads.

Traditional trailer hitches do not provide real-time feedback on trailer loads. The lack of feedback can be dangerous; a towing vehicle may be unaware of the trailer loads, resulting in undesirable or poor braking and/or acceleration performance. Known towing sensors are typically unable to measure both vertical load and axial load. Thus, there is a need for a hitch sensor assembly that can measure both axial and vertical loads.

### SUMMARY

In some embodiments, an apparatus includes a coupler configured to couple a trailer to a hitch of a tow vehicle. A bracket can be coupled to a body of the trailer. At least one sensor can be disposed at an interface of the coupler and the bracket. The at least one sensor is configured to measure an axial force and a vertical force at the interface.

In some embodiments, a method for operating a motion system of a trailer includes receiving load data from at least one sensing pin disposed at an interface between a trailer and a tow vehicle. A vertical load and an axial load can be determined based on the load data. A motion system of the trailer, such as a motor, engine, or brake can be operated based on at least one of the vertical load or the axial load.

### BRIEF DESCRIPTION OF THE DRAWINGS

Reference should be made to the following detailed description which should be read in conjunction with the following figures, wherein like numerals represent like parts.

FIG. 1 is a schematic block diagram of a trailer hitch assembly, according to an embodiment.

FIGS. 2-4 are various views of a trailer hitch assembly, according to an embodiment.

FIGS. 5-9 are various views of at least a portion of a trailer hitch assembly, according to an embodiment.

FIGS. 10-15 are various views of at least a portion of a trailer hitch assembly, according to an embodiment.

FIG. 16 depicts a perspective view of an alternate trailer hitch assembly, according to an embodiment.

FIG. 17 depicts a perspective view of another alternative trailer hitch assembly, according to an embodiment.

FIG. 18 depicts an exploded view of the trailer hitch assembly of FIG. 17.

FIG. 19 depicts a perspective view of another alternative trailer hitch assembly, according to an embodiment.

FIG. 20 depicts an exploded view of the trailer hitch assembly of FIG. 19.

FIG. 21 depicts a flow chart of a method for operating a propulsion system of a trailer, according to an embodiment.

### DETAILED DESCRIPTION

Some embodiments described herein relate to a trailer hitch sensor assembly (e.g., trailer hitch assembly, trailer hitch apparatus, etc.) for coupling a trailer to a hitch of a tow vehicle. The trailer hitch sensor assembly includes one or more sensors configured to measure loads (e.g., forces) including an axial load (e.g., along an axis defined by the towing vehicle) and a vertical load. In some embodiments, the trailer hitch sensor assembly can include two sensors. The trailer hitch sensor assembly can include a coupler configured to couple to a hitch of a vehicle and a bracket coupled to a body of the trailer. The at least one sensor is disposed at an interface of the coupler and the bracket so that the axial loads and vertical loads associated with the trailer can be measured and/or determined.

During use, the trailer hitch sensor assembly can be used for determining an operational setting of a motion system (e.g., motor system, braking system, etc.) of the trailer. For example, the at least one sensor pin(s) can measure the axial loads and the vertical loads which can be used to determine one or more parameters associated with the trailer, such as a tongue weight, acceleration loads, deceleration loads, and/or the like. The axial loads can be used to determine operational settings associated with the trailer. For example, the operational settings can include operating a motor of at least one wheel of the trailer, operating a brake system of at least one wheel, operating a regenerative braking system, operating an anti-lock brake system, operating an anti-sway system, and/or the like.

The trailer hitch sensor assembly described herein can be used on a wide range of trailers including recreational vehicles. The trailer hitch sensor assembly is configured to increase the safety and efficiency of towing trailers.

In some embodiments, a trailer hitch assembly such as any of those described herein can include a coupler, a bracket, and a sensor. The coupler is configured to couple to a hitch of a tow vehicle. The bracket is configured to couple to a body of the trailer. The sensor is disposed at an interface of the coupler and the bracket and is configured to measure an axial force and a vertical force at the interface.

In some embodiments, a trailer hitch assembly such as any of those described herein can include a coupler, a bracket, an interface, and a sensing pin. The coupler is configured to couple to a hitch of a tow vehicle. The bracket is configured to couple to a body of the trailer. The interface is coupled between the coupler and the bracket. The sensing pin couples the interface to the bracket and forms a load path between the interface and the bracket such that the sensing pin measures an axial force and a vertical force at the interface.

In some embodiments, a method of operating a motion system of a trailer includes receiving load data from at least one sensing pin disposed at an interface between the trailer and a tow vehicle. A vertical load and an axial load associated with the tow vehicle towing the trailer is determined based on the load data. The motion system of the trailer is operated based on at least one of the vertical load or the axial load.

The present disclosure is not limited in its application to the details of construction and the arrangement of components set forth in the following description or illustrated in the drawings. The examples described herein may be capable of other embodiments and/or of being practiced or being carried out in various ways. Also, it may be appreciated that the phrasing and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of any particular embodiment may be equally applied to any other embodiment(s) of this specification as suitable. In other words, features between the various embodiments described herein are interchangeable, and not exclusive, unless such embodiments are mutually exclusive or unless otherwise stated.

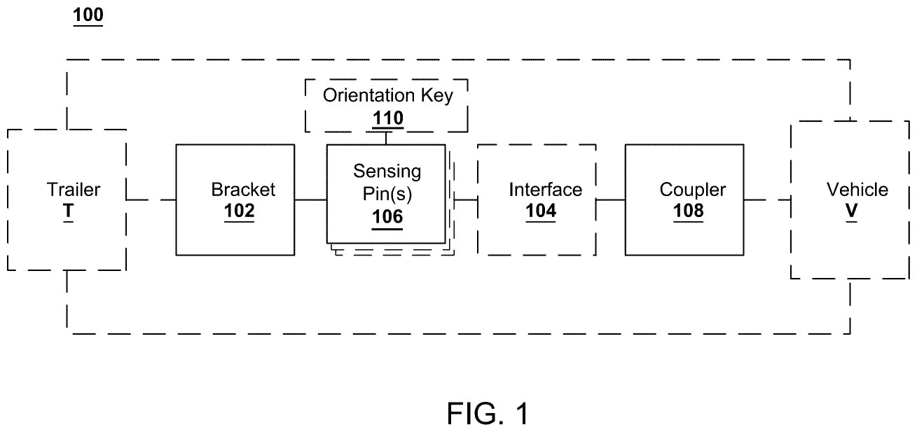

FIG. 1 is a schematic block diagram of a trailer hitch assembly 100, according to an embodiment. The trailer hitch assembly 100 is configured to couple a trailer T to a vehicle V. The vehicle V includes a ball mount, hitch, or similar mounting device. The trailer T includes a mounting point, receiver, or similar area to which the trailer hitch assembly 100 may be coupled (e.g., fixedly, selectively, etc.). In some embodiments, the trailer hitch assembly 100 can be configured to couple to the trailer T in a permanent or semi-permanent manner while being configured to selectively couple to the vehicle V. In some embodiments, the trailer hitch assembly 100 can be configured to communicably couple to a compute device associated with the trailer T and/or the vehicle V. In some embodiments, the trailer hitch assembly 100 can be configured to operatively couple to a power system and/or braking system of the trailer T and/or the vehicle V.

As shown, the trailer hitch assembly 100 includes a bracket 102, an interface 104, a set of sensors 106, a coupler 108, and an orientation key 110. In some embodiments, the set of sensors 106 can include one sensor or sensing device or multiple sensors or sensing devices. In some embodiments, the interface 104 and/or the orientation key 110 may be optional.

The bracket 102 is a supporting component configured to couple to the trailer T. In some embodiments, the bracket 102 can be coupled to the trailer T via a fastener (e.g., screw, nut/bolt, clip, pin, etc.), a weld, an adhesive, and/or the like. In some embodiments, the bracket 102 can be integrally formed with the trailer T and/or with or by one or more components of the trailer T. In some embodiments, the bracket 102 can be formed of steel, stainless steel, cast iron, aluminum, composite, plastic, and/or the like. When coupled to the trailer T, the bracket 102 is configured to withstand the forces associated with towing the trailer T at a desired operating condition. In some embodiments, the bracket 102 can include a mounting portion (e.g., a first portion configured to couple to the trailer T) and a coupling portion (e.g., a second portion configured to couple to the interface 104 and/or coupler 108). The mounting portion can be a substantially flat surface, plate, and/or the like that defines a plurality of mounting holes. The mounting holes can be used to couple the bracket 102 to the trailer T via one or more fasteners (e.g., bolts, welds, rivets, etc.). The coupling portion is configured to extend away from the mounting portion. In some embodiments, the coupling portion can include one or more section. For example, the coupling portion can include a single portion (e.g., a tang, protrusion, etc.), two portions defining a C-shape, three portions defining an E-shape, and/or the like. The coupling portion is configured to couple to and/or interface with the set of sensor(s) 106. For example, the coupling portion can define one or more aperture configured to accept the set of sensors 106 such as one or more sensing pin(s). The coupling portion can also be configured to engage a portion of the interface 104 and/or the coupler 108. In some embodiments, the coupling portion can include a shoulder or other feature configured to receive or engage the interface 104 and/or the coupler 108. In some embodiments, the shoulder or other feature can include a baffle (e.g., padding, elastic, rubber, etc.).

The interface 104 is configured to engage and/or couple to the coupler 108. In other embodiments, the bracket 102 can engage and/or couple to the coupler 108 without the interface 104. For example, the interface 104 or one or more portions thereof can be integrated into the bracket 102 and/or the coupler 108.

In some embodiments, the interface 104 can be formed of steel, stainless steel, cast iron, aluminum, composite, plastic, and/or the like. The interface 104 can include a first portion configured to engage the bracket 102 and a second portion configured to engage the coupler 108. In some embodiments, the first portion can include a tang or any other suitable feature configured to be accepted by and/or coupled to the coupling portion of the bracket 102. For example, the first portion of the interface 104 can define a cavity shaped and/or sized to at least partially receive the coupling portion of the bracket 102. Alternatively, the coupling portion of the bracket 102 can define a cavity shaped and/or sized to at least partially receive the first portion of the interface 104.

As described above with reference to the bracket 102, the interface 104 is configured to couple to and/or interface with the set of sensor(s) 106. For example, the first portion can include or define one or more apertures configured to align with the one or more aperture of the bracket 102 so that one or more sensors (e.g., one or more sensing pins or any other suitable sensor(s)) can be accepted through the apertures of the interface 104 and the corresponding apertures of the bracket 102. Such an arrangement can allow for the forces between the bracket 102 and the interface 104 to be detected and/or measured by the one or more sensor(s) 106. In some embodiments, one or more spacer(s) can be included between the interface 104 and the bracket 102 to reduce wear and maintain proper alignment of the assembly. In some embodiments, the interface 104 and the bracket 102 are configured such that the interface 104 and the bracket 102 are not in contact and/or do not otherwise engage in a manner that transmits loads during operation so that the forces (e.g., at least in the axial and vertical directions) are only transferred through the set of sensor(s) 106 (e.g., sensing pins).

In some embodiments, the second portion of the interface 104 can include or can be coupled to one or more covers (e.g., shield, plate, etc.) configured to cover and protect the set of sensor(s) 106 coupled thereto. The second portion of the interface 104 extends away from the first portion. The second portion can be a tang or any other suitable feature configured to engage a receiving portion of the coupler 108. In some embodiments, the second portion includes one or more apertures configured to align with one or more apertures of the coupler 108. One or more fasteners (e.g., screw, nut/bolt, clip, etc.) can be used to couple the interface 104 to the coupler 108 so that forces are transmitted between the coupler 108 and the interface 104. Thus, the interface 104, when the first portion is coupled to the bracket 102 (e.g., in a manner that forms a load path through the sensor(s) 106) and the second portion is coupled to the coupler 108, allows for forces and/or loads to be transmitted between the coupler 108 and the bracket 102 and for such forces to be detected, measured, and/or sensed by the sensor(s) 106 (e.g., sensing pins). In some embodiments, the interface 104 and the coupler 108 can be integrally formed.

The coupler 108 is configured to couple to the trailer hitch assembly 100 to the vehicle V. In some embodiments, the coupler 108 is formed of steel, stainless steel, cast iron, aluminum, composite, plastic and/or the like. In some embodiments, the coupler 108 can include a ball coupler, a kingpin, pintle ring, a clevis coupler, and/or the like. The coupler 108 is configured to couple to a receiver on the vehicle V so that the trailer hitch assembly 100 can rotate about the coupling point between the coupler 108 and the receiver of the vehicle V. The coupler 108 includes a first portion configured to couple to the vehicle V and a second portion configured to couple to the bracket 102 and/or the interface 104. The second portion can extend away from the first portion. In some embodiments, the second portion can be shaped to couple to and/or receive the second portion (e.g., a coupling portion of the interface 104 and/or the bracket 102. For example, the second portion of the coupler 108 can form a C-shape that is configured to receive a tang or other suitable feature (e.g., second portion) of the interface 104 and/or the bracket 102. As discussed above, the coupler 108 includes one or more apertures for coupling the coupler 108 to the interface 104. In some embodiments, the coupler 108 may couple directly to the bracket 102 via the sensor(s) 106 and/or otherwise in a manner that allows the sensor(s) 106 to detect, sense, and/or measure the forces between the coupler 108 and the bracket 102. In some embodiments, the coupler 108 can include a fastener configured to selectively couple the coupler 108 to the vehicle V. For example, the fastener can include a lever, a pin, a hook, and/or the like. The fastener is configured to allow for rotation while preventing the coupler 108 from detaching from the receiver of the vehicle V.

The set of sensor(s) 106 can include one or more sensor or sensing device configured to measure forces or loads in one or more directions. In some embodiments, for example, the sensor(s) 106 can be and/or can include sensing pins or load pins configured to measure axial forces and/or vertical forces during the operation of the trailer hitch assembly 100. In some implementations, including sensing pins can be advantageous as they can be configured to function as a mechanical attachment point as well as a sensing device. While examples provided herein describe the set of sensor(s) 106 as being one or more sensing or load pins, it should be understood that the use of other sensor(s) is also possible. Accordingly, the discussion of the sensor(s) 106 being arranged as sensing pins is intended by way of example only and is not intended to exclude the use of other sensors or combination of sensors.

In some embodiments, the sensor(s) 106 can be and/or can include single axis sensing pins operable to measure force in a single direction and output a signal that corresponds to a magnitude of the measured force. In other embodiments, the sensor(s) 106 can be and/or can include one or more multi-axis sensing pin(s) operable to measure force in multiple directions and output a signal corresponding to one or more vector associated with the measured force. The sensing pins can also be configured to transfer axial and vertical loads between the interface 104 (and/or the coupler 108) and the bracket 102 via shear loading on the sensing pins. In some embodiments, the set of sensor(s) 106 can include a first sensing pin and a sensing pin that are substantially similar sensors. In some embodiments, including the two sensing pins can allow for redundancy if one of the sensing pins were to fail. In some embodiments, the set of sensor(s) 106 can include additional sensing pins. In some embodiments, the set of sensor(s) 106 can be arranged such that the first sensing pin is positioned vertically above the second sensing pin to allow for simultaneous measurement of axial (e.g., tow) loads and vertical (e.g., hitch) loads. In some embodiments, the sensing pin(s) may be configured to measure loads in both the positive and negative direction. In some embodiments, the sensing pin(s) may be configured to measure moments (e.g., moment forces) for determining the vertical load placed on the vehicle V by the trailer T.

In some embodiments, the sensing pins can be cylindrical and configured to be disposed in and/or to otherwise engage apertures in the bracket 102 and the interface 104 and/or the coupler 108. In some embodiments, the sensing pins can include electrical coupling points configured to couple to a wire for transmitting measurements and/or for receiving power. In some embodiments, the sensing pins can include caps, and/or similar components to prevent the sensing pins from sliding out of the apertures during operation. In some embodiments, the sensing pins can include a keying feature for positioning the sensing pins in a desired orientation (e.g., to lock a sensing axis of sensing pins in a known/fixed position). For example, as shown in FIG. 1, the trailer hitch assembly 100 can include the orientation key 110 (e.g., pin key) that is configured to engage the keying feature of the sensing pins to orient the sensing pins in a desired orientation and to prevent the sensing pins from moving, shifting, rotating, etc. during operation. In some embodiments, the orientation key 110 may be configured to prevent the sensing pins from sliding out of the apertures of the bracket 102 and/or the interface 104 (or coupler 108) during operation. In some embodiments, the orientation key 110 may be fastened to the bracket 102 and/or the interface 104 or the coupler 108. In some embodiments, the orientation key 110 may be substantially rectangular and configured to engage any number of sensing pins included in the set of sensor(s) 106. In some embodiments, the trailer hatch assembly 100 can include more than one orientation key 110 such that each sensing pin can include a corresponding orientation key 110.

In some implementations, using sensing pins as the sensor(s) 106 can allow for improved signal resolution and accuracy as well as improved mechanical reliability and safety over conventional methods of measuring towing loads. However, as described above, it will be appreciated that other methods of measuring vertical loads and/or axial loads may be used instead of or in addition to the sensing pins. For example, the set of sensor(s) 106 can be and/or can include other sensors such as load cells, strain gauges, spring-displacement sensors, fluid cylinder pressure sensors, and/or the like.

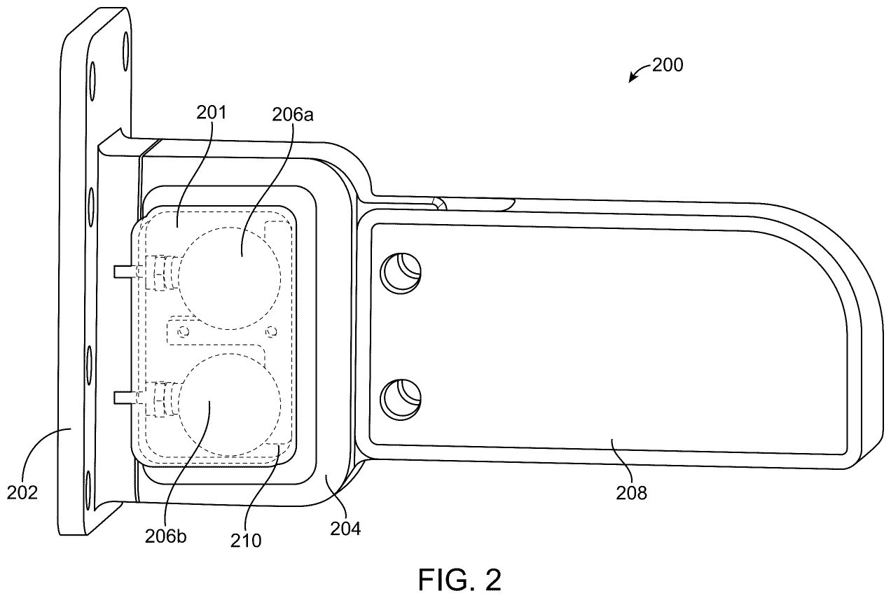

FIGS. 2-4 are various views of a trailer hitch assembly 200, according to an embodiment. The trailer hitch assembly 200 is configured to couple a vehicle (e.g., the vehicle V) to a trailer (e.g., the trailer T) while measuring axial loads and/or vertical loads associated with the vehicle and/or the trailer. In some embodiments, the trailer hitch assembly 200 can be used with a variety of trailers such as utility trailers, recreational vehicles, and/or the like. In some embodiments, the trailer hitch assembly 200 can be used with a variety of vehicles such as medium duty trucks, heavy duty trucks, light duty trucks, sports utility vehicles, and/or the like. As shown in FIG. 2, the trailer hitch assembly 200 includes a bracket 202, an interface 204, a first sensing pin 206a, a second sensing pin 206b, a cover 203, an orientation key 210, and a coupler 208. The bracket 202, the interface 204, the sensing pins 206a/206b, the orientation key 210, and the coupler 208 can be functionally and/or structurally similar to the bracket 102, the interface 104, the sensors 106 (e.g., sensing pins), the orientation key 110, and the coupler 108, respectively. Accordingly, portions and/or aspects of the trailer hitch assembly 200 that are similar in at least form and/or function to the corresponding portions and/or aspects of the trailer hitch assembly 100 may not be described in further detail herein.

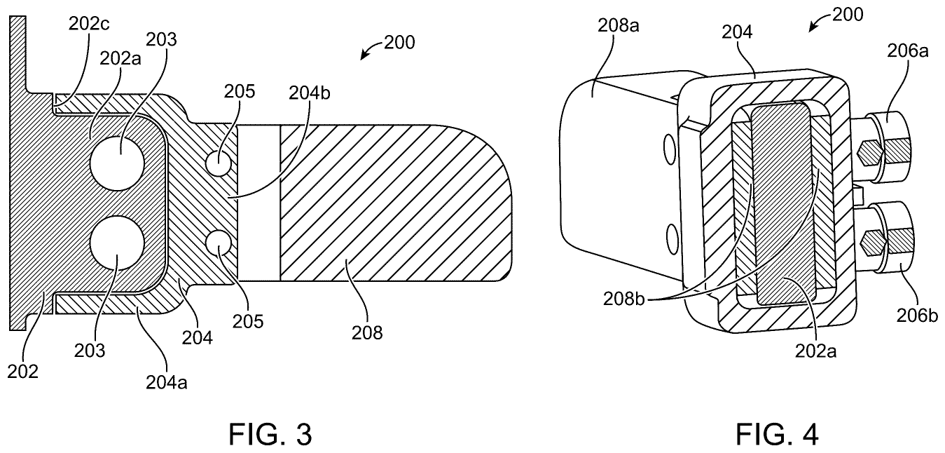

The bracket 202 includes a substantially flat first portion (e.g., flat datum surface, mounting portion, plate, etc.) configured to couple to a receiving portion of a trailer. The first portion includes a plurality of openings disposed around the perimeters of the bracket 202. The openings are configured to receive a fastener for coupling to the trailer and/or to allow for wires, cables, etc. to be passed through. The bracket 202 is substantially rectangular with rounded corners. A second portion extends away from the first portion. As shown in the cross-sectional view of FIG. 3, the second portion includes and/or forms a tang 202a extending away from the first portion as well as a shoulder 202b around the base of the tang 202a. The tang 202a defines two apertures 203 which are vertically oriented. The apertures 203 are configured to receive the first sensing pin 206a and the second sensing pin 206b.

The interface 204 includes a first portion 204a that is substantially rectangular and defines a cavity. The cavity is configured to receive the tang 202a of the bracket 202 such that the interface 204 abuts or nearly abuts the shoulder 202b. As shown in FIG. 4, a section view taken through the interface 204, the coupler 208 can include tangs 208a that extend into the interface 204 to sandwich the tang 202a of the bracket 202 (e.g., at least a portion of the tang 202a of the bracket 202 is positioned between the tangs 208a of the coupler 208). The first portion 204a of the interface 204 includes apertures configured to align with the apertures 203 of the bracket 202, allowing the sensing pins 206a, 206b to be inserted into the apertures of the interface 204 and the apertures 203 of the bracket 202, thereby coupling the interface 204 to the bracket 202. The sensing pins 206a, 206b transmit forces between the interface 204 and the bracket 202 while measuring said forces both axially and vertically. In some embodiments, the arrangement of the bracket 202, the interface 204, and the sensing pins 206a, 206b is such that the sensing pins 206a, 206b provide the only or substantially the only load path between the bracket 202 and the interface 204 (e.g., at least in the axial and vertical directions). In contrast, other connections or contact between one or more portions of the bracket 202 and one or more portions of the interface 204 do not form such load paths and/or are otherwise configured to not transmit significant forces in at least the axial and vertical directions. Such an arrangement is advantageous as it allows the pins 206a, 206b to measure the forces (e.g., at least in the axial and vertical directions) transmitted between the bracket 202 and the interface 204.

The sensing pins 206a, 206b can be covered by the cover 203 (FIG. 2) which can protect the sensing pins 206a, 206b (and/or any electrical interface, connector, controller, etc. associated with the sensing pins 206a, 206b. In some embodiments, the cover 203 is fastened and/or adhered to the interface 204. In some embodiments, the cover 203 can be a casing, an overmold, a heat-shrink wrapping, and/or any other suitable cover 203. The interface 204 includes a second portion 204b extending away from the first portion 204a (see e.g., FIG. 3). The second portion 204b is and/or forms a tang that is configured to engage protrusions (or portions of the tangs 208b) of the coupler 208. The second portion 204b includes and/or defines apertures 205 that are configured to align with apertures defined by the protrusions (or tangs 208b) of the coupler 208. In some embodiments, fasteners (bolts, pins, etc.) can be used to couple the interface 204 to the coupler 208. Opposite the protrusions and/or tangs 208b, the coupler 208 includes a portion 208a (e.g., a coupler, a receiver, a cup, etc.) that is configured to engage or couple to a hitch of a vehicle (e.g., a ball hitch). In some embodiments, the portion 208a (e.g., the coupler, receiver, cup, etc.) can be similar to known couplers.

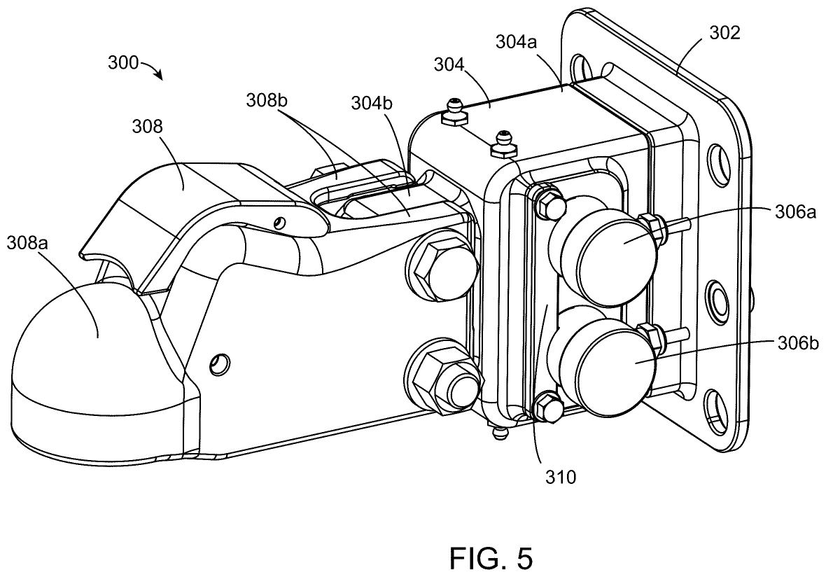

FIGS. 5-9 are various views of at least a portion of a trailer hitch assembly 300, according to an embodiment. As shown in FIG. 5, the trailer hitch assembly 300 includes a bracket 302, an interface 304, a first sensing pin 306a, a second sensing pin 306b, a coupler 308, an orientation key 310, and spacers 309. The bracket 302, the interface 304, the sensing pins 306a/306b, the coupler 308, and the orientation key 310 can be functionally and/or structurally similar to the brackets 102, 202, the interfaces 104, 204, the sensing pins 206a/206b (or more generally, the sensors 106), the couplers 108, 208, and the orientation keys 110, 210, respectively. Accordingly, portions and/or aspects of the trailer hitch assembly 300 that are similar in at least form and/or function to the corresponding portions and/or aspects of the trailer hitch assemblies 100, 200 may not be described in further detail herein.

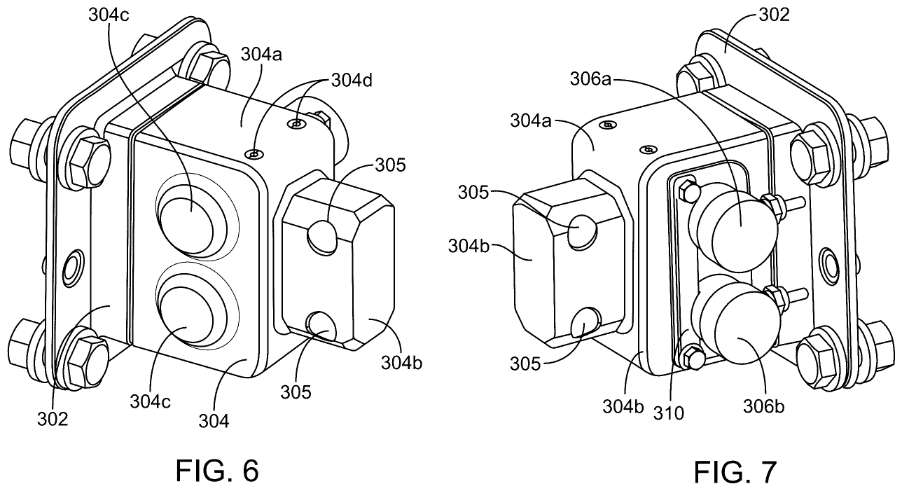

FIGS. 6-9 are various views showing details of the bracket 302, the interface 304, the sensing pins 306a, 306b, the spacers, and the orientation key 310, which are coupled to form an assembly or subassembly that, in turn, can be coupled to the coupler 308 (not shown in FIGS. 6-9). The bracket 302 is substantially similar to the bracket 202 but includes a mounting portion (e.g., flat surface, plate, etc.) that is substantially square with rounded corners and similarly includes a plurality of openings along the perimeter which can be used for coupling the bracket 302 to a trailer and for wires and/or cables to pass through. The bracket 302 additionally includes a keying feature (e.g., along or formed by a second portion, tang, and/or the like) that is configured to engage a corresponding keying feature on the spacers 309 to maintain the spacers 309 in a desired position or orientation during operation, as shown in the section view of FIG. 9. The spacers 309 also include apertures configured to receive, but to not be in contact with, the first sensing pin 306a and the second sensing pin 306b such that forces between the bracket 302 and the interface 304 are transmitted via the sensing pins 306a, 306b and not transferred, dissipated, and/or transmitted by the spacers 309.

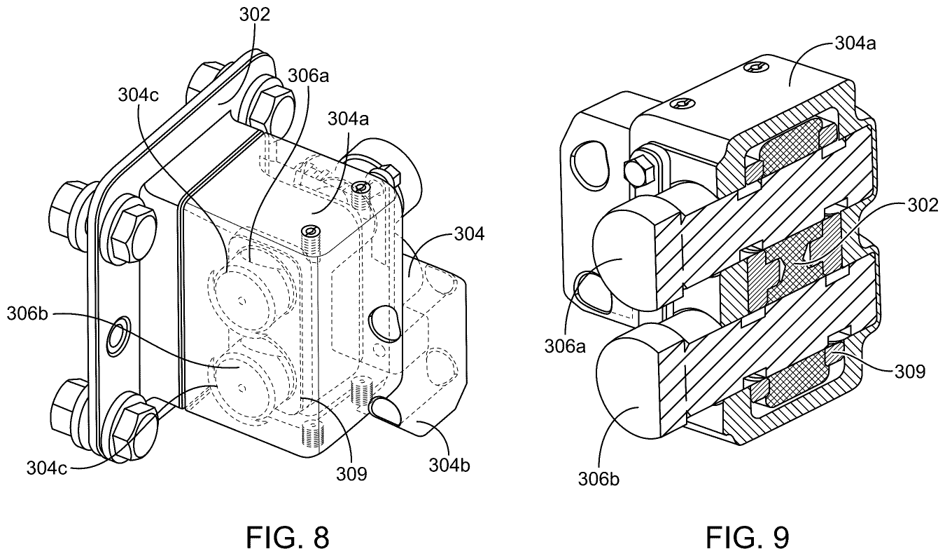

The interface 304 is substantially similar to the interface 204. As shown in FIG. 6, the first portion 304a (e.g., functionally and/or structurally similar to the first portion 204a of FIGS. 2-4) of the interface 304 defines apertures 303 into which the first sensing pin 306a or the second sensing pin 306b is inserted. As shown in FIG. 7, the first portion 304a also forms two protrusions 304c (e.g., cups, caps, etc.). Each of the protrusions 304c (e.g., cups, caps, etc.) defines a cavity or recess into which the first sensing pin 306a or the second sensing pin 306b extends, as shown in FIG. 8 (depicting the interface 304 as translucent to show the components or portions of the components disposed therein). In some embodiments, the first portion 304a can include a single protrusion 304c configured to define one cavity or recess that receives both sensing pins 306a, 306b. The first portion 304a also includes two grease fittings 304d (e.g., Zerk fittings, grease nipple, grease zerk, grease port, etc.). In some embodiments, the first portion 304a can include any number of grease fittings 304d. The grease fittings 304d allow for grease (e.g., lubricant) to be directed into the space between the bracket 302 and the interface 304. The grease lubricates the components and reduces moisture ingress as well as protecting the components from moisture and corrosion.

The orientation key 310 is configured to couple to the first portion 304a of the interface 304 in a manner that allows the orientation key 310 to engage a slot of the sensing pins 306a, 306b as depicted in FIG. 7. The orientation key 310 is fastened to the first portion 304a of the interface 304 to prevent the sensing pins 306a, 306b from sliding out or rotating during operation. The orientation key 310 and the sensing pins 306a, 306b can be similar to or substantially the same as the orientation key 210 and the sensing pins 206a, 206b, respectively, and are not described in further detail herein. A second portion 304b of the interface 304 (e.g., functionally and/or structurally similar to the second portion 204b of the interface 204 shown in FIGS. 2-4) is and/or forms a substantially rectangular tang with rounded corners. The second portion 304b is configured to couple to the coupler 308 via fasteners extending through the apertures 305.

Referring back to FIG. 5, the coupler 308 includes a first portion 308a and a second portion 308b. The first portion 308a of the coupler 308 is configured to engage or couple to a receiver or hitch of the vehicle (e.g., a ball hitch). In some embodiments, the first portion 308a of the coupler 308 can be similar to known couplers and therefore is not described in further detail herein. The second portion 308b of the coupler 308 is configured to be coupled to the second portion 304b of the interface 304. For example, the second portion 308b can include and/or can form tangs configured to receive the second portion 304b of the interface 304 therebetween (e.g., the tangs extend on opposite sides of the second portion 304b of the interface 304, sandwiching the second portion 304b therebetween). The second portion 308b of the coupler 308 can be coupled to the second portion 304b of the interface 304 via any number of fasteners (e.g., bolts and nuts) and/or the like.

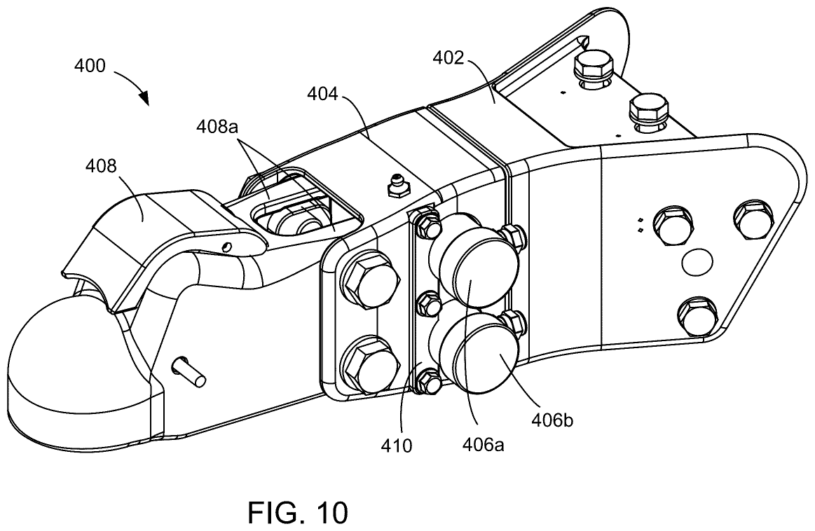

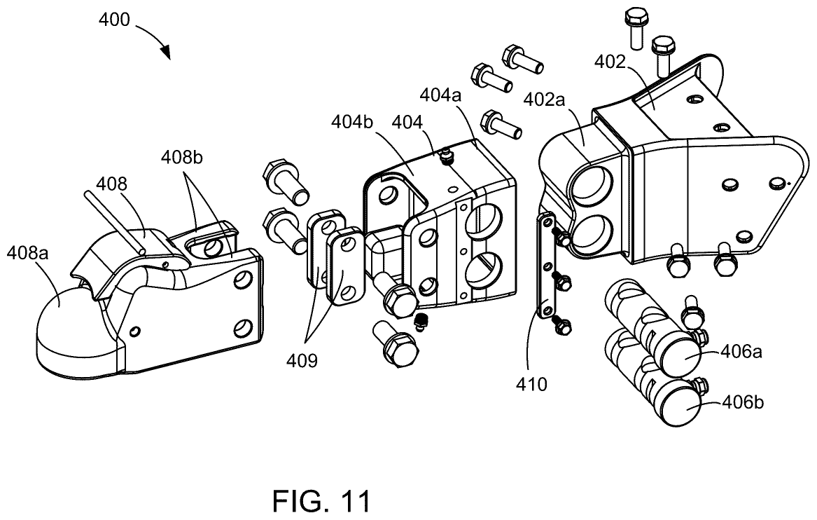

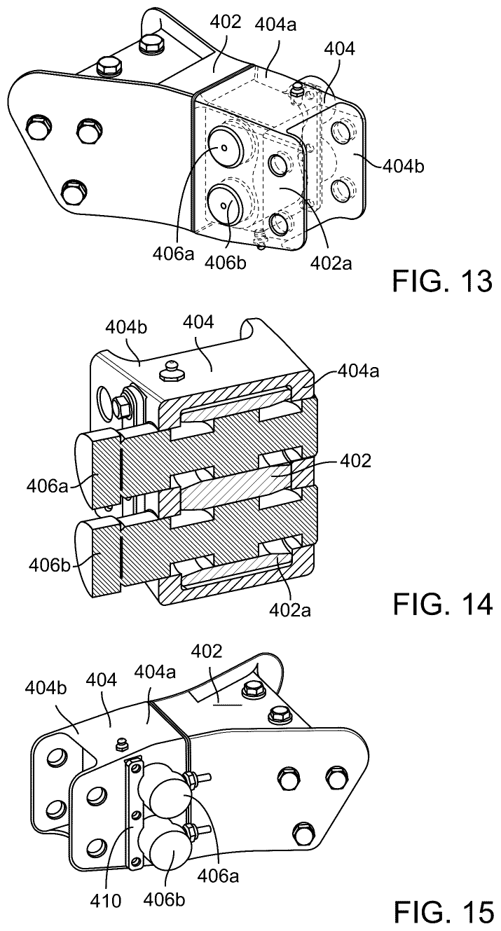

FIGS. 10-15 are various views of a trailer hitch assembly 400, according to an embodiment. As described above, the trailer hitch assembly 400 is configured to couple a trailer (e.g., the trailer T of FIG. 1) to a vehicle (e.g., the vehicle V of FIG. 1) while measuring loads and/or forces (e.g., axial loads, vertical loads, and/or the like) associated with the vehicle, the trailer, and/or the connection therebetween. The trailer hitch assembly 400 can be used with a variety of trailers such as utility trailers, recreational vehicles, and/or the like, and with a variety of vehicles such as light duty trucks, medium duty trucks, heavy duty trucks, sports utility vehicles, and/or the like. The trailer hitch assembly 400 can be functionally and/or structurally similar to any of the trailer hitch assemblies 100, 200, 300 described herein. For example, as shown in FIGS. 10 and 11, the trailer hitch assembly 400 includes a bracket 402, an interface 404, a first sensing pin 406a, a second sensing pin 406b, a coupler 408, spacers 409, and an orientation key 410, which can be functionally and/or structurally similar to the brackets 102, 202, 302, the interfaces 104, 204, 304, the sensing pins 206a/206b, 306a/306b, (or more generally, the sensors 106 of FIG. 1), the couplers 108, 208, 308, the spacers 309, and the orientation keys 110, 210, 310, respectively. Accordingly, portions and/or aspects of the trailer hitch assembly 400 that are similar in at least form and/or function to the corresponding portions and/or aspects of the trailer hitch assemblies 100, 200, 300 may not be described in further detail herein.

The bracket 402 is substantially similar to the bracket 202 but includes a mounting portion that is flared and that is hollow or otherwise defines an inner space configured to receive a portion of the trailer. For example, the trailer may include a structure or tongue that can extend from a front portion of the trailer and into the inner space defined by the bracket 402. In other words, the bracket 402 can be coupled to and/or disposed on or about a structural component of the trailer. The bracket 402 can be coupled to the structure (e.g., tongue) of the trailer via any number of bolts, fasteners, and/or the like. Alternatively, the bracket 402 can be fixedly attached to the structure of the trailer via welding or other permanent or semi-permanent attachment. Although not shown, the bracket 402 can include any suitable opening, hole, aperture, and/or feature configured to allow wire and/or cables (e.g., associated with the sensing pins 406a/406b) to pass therethrough.

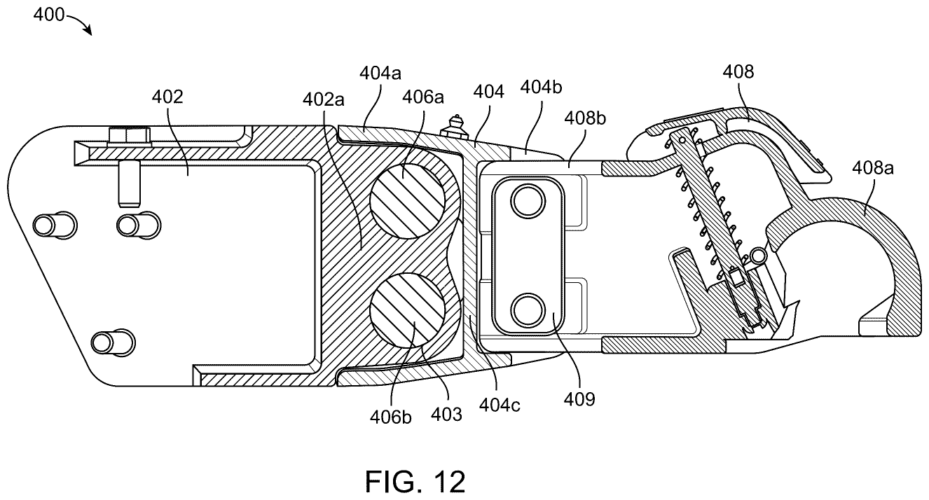

The bracket 402 includes an interface portion 402a (e.g., similar to the second portion or tang 202a). The interface portion 402a defines two apertures 403 that are vertically oriented or aligned, and configured to receive a portion of the first sensing pin 406a and a portion of the second sensing pin 406b therethrough. The interface portion 402a is configured to engage or couple the bracket 402 to the interface 404. More specifically, the interface portion 402a of the bracket 402 is sized and shaped to fit within a portion of the interface 404 without or substantially without structural or load bearing contact with a surface of the interface 404 (see e.g., FIG. 12). As such, forces between the bracket 402 and the interface 404 encountered during towing are transmitted via the sensing pins 406a, 406b and not transferred, dissipated, and/or otherwise transmitted via contact between the bracket 402 and the interface 404.

The interface 404 is substantially similar to the interface 204 and/or 304. For example, the interface 404 includes a first portion 404a (e.g., functionally and/or structurally similar to the first portion 204a and/or 304a) and a second portion 404b (e.g., functionally and/or structurally similar to the first portion 204b and/or 304b). As shown in FIGS. 11-14, the first portion of 404a of the interface 404 is configured to receive and/or couple to the interface portion 402a of the bracket 402. The first portion 404a of the interface 404 defines a set (e.g., two) apertures 403 into which the first sensing pin 406a or the second sensing pin 406b is inserted. Unlike the first portion 304a of the interface 304, in this embodiment, the first portion 404a of the interface 404 includes apertures on both sides of the interface 404 allowing the sensing pins 406a, 406b to extend through the interface 404. Alternatively, the first portion 404a of the interface 404 can form one or more protrusions or can include a cover or overmolded portion that forms one or more protrusions into which and end portion of the first sensing pin 306a or the second sensing pin 306b extends. As described above with reference to the interface 304, the first portion 404a of the interface 404 can include any number of fittings, ports, nipples, access points, etc. configured to allow access into an interior of the first portion 404a (e.g., when the coupled to the interface portion 402a of the bracket 402). For example, such fittings, ports, nipples, access points, etc. can be grease fittings or the like allowing grease or any other suitable lubricant to be injected or added into the space between the bracket 402 and the interface 404. The grease lubricates the components, reduces friction between the components, and reduces moisture ingress (protecting the components from moisture and corrosion).

As shown in FIGS. 11 and 15, the first portion 404a of the interface 404 is configured to receive or to be coupled to the orientation key 410 in a manner that allows the orientation key 410 to engage a slot defined by the sensing pins 406a, 406b. For example, the orientation key 410 is fastened to the first portion 404a of the interface 404 to prevent the sensing pins 406a, 406b from sliding out or rotating during operation. The orientation key 410 and the sensing pins 406a, 406b can be similar to or substantially the same as the orientation key 210 and the sensing pins 206a, 206b, respectively, and are not described in further detail herein.

Referring back to FIG. 10, the coupler 408 includes a first portion 408a and a second portion 408b. The first portion 408a of the coupler 408 is configured to engage or couple to a receiver or hitch of the vehicle (e.g., a ball hitch). In some embodiments, the first portion 408a of the coupler 408 can be similar to known couplers and therefore is not described in further detail herein. The second portion 408b of the coupler 408 is configured to be coupled to the second portion 404b of the interface 404. For example, the second portion 404b of the interface 404 (e.g., functionally and/or structurally similar to the second portion 304b of the interface 304 shown in FIGS. 5-9) is and/or forms a substantially C-shape extension that is configured to receive and couple to the second portion 408b of the coupler 408. Similarly, the second portion 408b of the coupler 408 can include and/or can form a substantially C-shaped extension and/or can otherwise form tangs, arms, protrusions, etc. configured to be disposed within a space defined by the second portion 404b of the interface 404. For example, as shown in FIG. 10, the second portion 408b of the coupler 408 can be sized and shaped to fit within the second portion 404b of the interface 404 and can be coupled via any number of fasteners (e.g., bolts and nuts).

As shown in FIGS. 11 and 12, the spacers 409 can be positioned against an inner surface of the second portion 408b of the coupler 408 and can define a set of openings that receive the fasteners. In this manner, the spacers 409 can be configured to stiffen or support the coupling between the coupler 408 and the interface 404, which can limit and/or reduce twisting and/or pivoting of the coupler 408 relative to the interface 404. Moreover, while the bracket 402 is described above as being coupled to the interface 404 in a manner that allows the sensing pins 406a, 406b to form a load path between the bracket 402 and the interface 404, the coupling of the second portion 408b of the coupler 408 to the second portion 404b of the interface 404 is a substantially rigid connection such that forces and/or loads are transferred therebetween. Such an arrangement can allow the sensing pins 406a, 406b to form a load path between the interface 404 and the bracket 402 that allows the sensing pins 406a, 406b to measure, detect, and/or sense forces and/or loads (e.g., at least axial loads and vertical loads) associated with the vehicle, the trailer, and/or the connection therebetween.

Although not shown in FIGS. 10-15, the sensing pins 406a, 406b can be in communication with a compute device, controller, and/or the like. The compute device or controller is configured to execute instructions, processes, functions, etc. based at least in part on signals received from the sensing pins 406a, 406b (e.g., load data that is based at least in part on the loads measured, detected, and/or sensed by the sensing pins 406a, 406b). In some implementations, the instructions, processes, functions, etc. can be associated with operating and/or controlling a motion system of the trailer, which can include, for example, an engine, motor, brake system, and/or the like. In some implementations, the compute device or controller can be configured to provide at least a portion of the load data received from the sensing pins 406a, 406b to a compute device and/or control system of the vehicle, which in turn, can use at least the portion of the load data to inform decisions associated with operating and/or controlling the vehicle (e.g., a motion system of the vehicle).

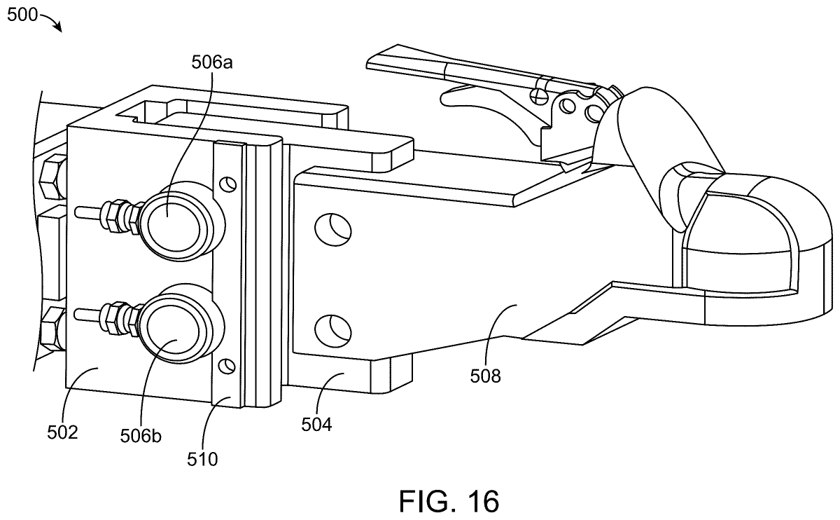

FIG. 16 depicts a perspective view of an alternate trailer hitch assembly 500 (e.g., functionally and/or structurally similar to the trailer hitch assembly 100, 200, 300, 400 described above with reference to FIG. 1, FIGS. 2-4, FIGS. 5-9, and FIGS. 10-15, respectively), according to an embodiment. Similar to the other trailer hitch assemblies described herein, the trailer hitch assembly 500 is configured to couple a trailer (e.g., the trailer T) to a vehicle (e.g., the vehicle V) and to measure both axial loads and vertical loads associated with the vehicle and/or the trailer (and/or the forces or loads transmitted therebetween). In some embodiments, the trailer hitch assembly 500 can be used with a variety of trailers such as utility trailers, recreational vehicles, and/or the like. In some embodiments, the trailer hitch assembly 500 can be used with a variety of vehicles such as light duty trucks, medium duty trucks, heavy duty trucks, sports utility vehicles, and/or the like. The trailer hitch assembly 500 includes a bracket 502, an interface 504, a first sensing pin 506a, a second sensing pin 506b, an orientation key 510, and a coupler 508. The bracket 502, the interface 504, the sensing pins 506a/406b, the orientation key 510, and the coupler 508 can be functionally and/or structurally similar to the brackets 102, 202, 302, 402 the interfaces 104, 204, 304, 404, the sensing pins 206a/206b, 306a/306b, 406a/406b (or more generally, the sensors 106), the orientation keys 110, 210, 310, 410, and the couplers 108, 208, 308, 408, respectively. Accordingly, portions and/or aspects of the trailer hitch assembly 500 that are similar in at least form and/or function to the corresponding portions and/or aspects of the trailer hitch assemblies 100, 200, 300, and/or 400 are not described in further detail herein.

The bracket 502 is configured to couple to a vehicle. The bracket 502 defines a C-shaped cross section that defines a channel between two protrusions. Each protrusion includes two vertically stacked apertures that are configured to receive the sensing pin 506a, 506b. The channel is configured to receive the interface 504 which includes apertures that are configured to align with the apertures of the bracket 502. The sensing pins 506a, 506b, when disposed within the apertures, couple the bracket 502 to the interface 504 such that force transmits between the bracket 502 and the interface 504 via the sensing pins 506a, 506b. The orientation key 510 is configured to engage slots in the sensing pins 506a, 506b to prevent the sensing pins 506a, 506b from rotating and/or falling out of the apertures during operation. The interface 504 is a tang that is configured to engage the channel of the bracket 502 as well as a channel defined by a C-shaped portion of the coupler 508. The interface 504 and the coupler 508 define additional apertures that are configured to allow for a fastener to fixedly couple the interface 504 to the coupler 508. The coupler 508 includes a portion that is configured to selectively couple to a ball hitch of a vehicle.

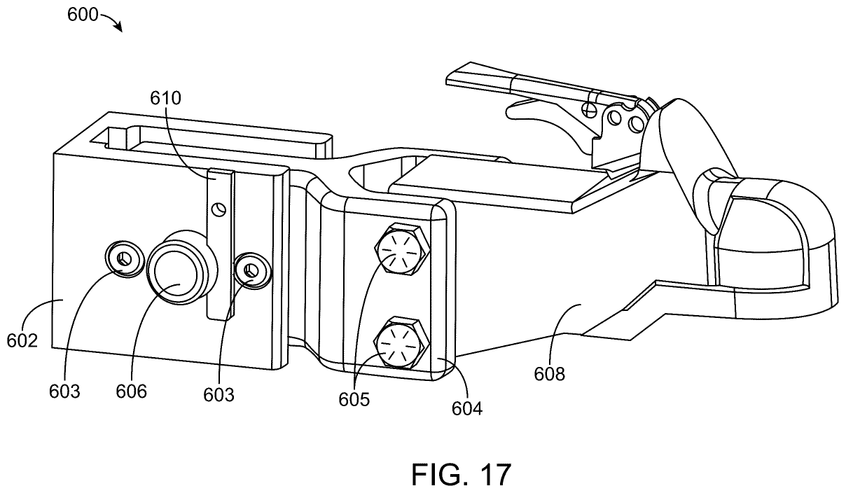

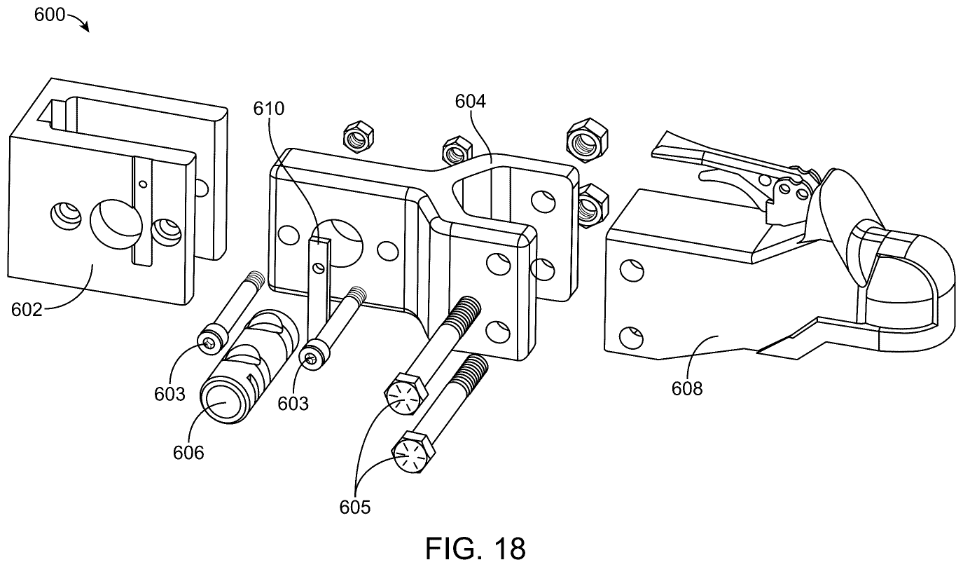

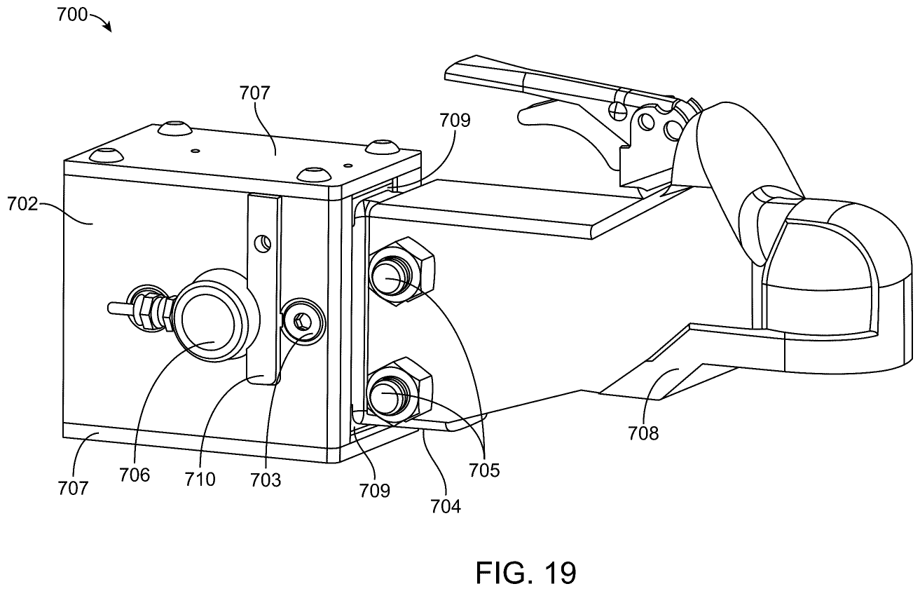

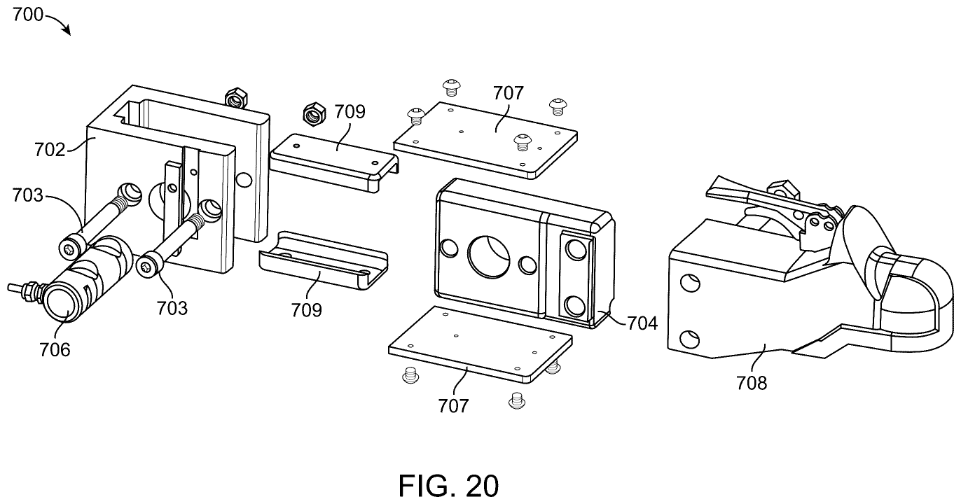

Referring generally to FIGS. 17-20, alternate trailer hitch assemblies 600 (FIGS. 17-18) and 700 (FIGS. 19-20) are shown, according to different embodiments. The trailer hitch assemblies 600, 700 can be functionally and/or structurally similar to the trailer hitch assemblies 100, 200, 300, 400, 500 described above with reference to FIG. 1, FIGS. 2-4, FIGS. 5-9, FIGS. 10-15, and FIG. 16, respectively. In these embodiments, the trailer hitch assemblies 600, 700 include a single sensing pin 606, 706, respectively. The sensing pins 606, 706 can be functionally and/or structurally similar to the sensing pins 206a/206b, 306a/306b, 406a/406b, and/or 506a/506b (or more generally, the sensors 106). In some embodiments, the trailer hitch assemblies 600, 700 can include one or more additional sensing pins. Similar to the other trailer hitch assemblies described herein, the trailer hitch assemblies 600, 700 are configured to couple a trailer (e.g., the trailer T of FIG. 1) to a vehicle (e.g., the vehicle V of FIG. 1) and to measure both axial loads and vertical loads associated with the vehicle and/or the trailer (and/or the forces or loads transmitted therebetween). In some embodiments, the trailer hitch assemblies 600, 700 can be used with a variety of trailers such as utility trailers, recreational vehicles, and/or the like. In some embodiments, the trailer hitch assemblies 600, 700 can be used with a variety of vehicles such as light duty trucks, medium duty trucks, heavy duty trucks, sports utility vehicles, and/or the like.

FIGS. 17-18 depict the trailer hitch assembly 600. FIG. 17 depicts the trailer hitch assembly 600 when assembled and FIG. 18 depicts an exploded view of the trailer hitch assembly 600. The trailer hitch assembly 600 includes a bracket 602, an interface 604, a sensing pin 606, an orientation key 610, and a coupler 608. The bracket 602, the interface 604, the sensing pin 606, the orientation key 610, and the coupler 608 can be functionally and/or structurally similar to the brackets 102, 202, 302, 402, 502, the interfaces 104, 204, 304, 404, 504, the sensing pins 206a/206b, 306a/306b, 406a/406b, 506a/506b (or more generally, the sensors 106), the orientation keys 110, 210, 310, 410, 510, and the couplers 108, 208, 308, 408, 508 respectively. Accordingly, portions and/or aspects of the trailer hitch assembly 600 that are similar in at least form and/or function to the corresponding portions and/or aspects of the trailer hitch assemblies 100, 200, 300, 400, and/or 500 are not described in further detail herein.

The bracket 602 is configured to couple to a vehicle. The bracket 602 defines a C-shaped cross section that defines a channel between two protrusions. Each protrusion includes a larger central aperture that is configured to receive the sensing pin 606 and two smaller apertures configured to receive bracket bolts 603. The bracket bolts 603 are configured to receive vertical forces associated with a trailed so that the sensing pin 606 is shielded from forces in the vertical direction. The bracket bolts 603 are beneficial in configurations where measuring forces is desired primarily in the horizontal direction. The channel is configured to receive the interface 604 which includes an aperture that is configured to align with the apertures of the bracket 602. The sensing pin 606, when disposed within the central aperture, couples the bracket 602 to the interface 604 such that force transmits between the bracket 602 and the interface 604 via the sensing pin 606. The bracket bolts 603 provide further stability to prevent rotational forces from rotating the interface 604 relative to the bracket 602. The orientation key 610 is configured to engage a slot in the sensing pin 606 to prevent the sensing pin 606 from rotating and/or falling out of the aperture during operation.

The interface 604 includes a tang that is configured to engage the channel of the bracket 602 and a channel defined by a C-shaped portion of the interface 604 that is configured to receive a portion of the coupler 608. The C-shaped portion includes two protrusions that separate away from the tang. The interface 604 and the coupler 608 define additional apertures that are configured to allow for the insertion of coupler bolts 605 to fixedly couple the interface 604 to the coupler 608. The coupler 608 includes a portion that is configured to selectively couple to a ball hitch of a vehicle.

FIGS. 19-20 depict the trailer hitch assembly 700. FIG. 19 depicts the trailer hitch assembly 700 when assembled and FIG. 20 depicts an exploded view of the trailer hitch assembly 700. The trailer hitch assembly 700 includes a bracket 702, an interface 704, a sensing pin 706, an orientation key 710, and a coupler 708. The bracket 702, the interface 704, the sensing pin 706, the orientation key 710, and the coupler 708 can be functionally and/or structurally similar to the brackets 102, 202, 302, 402, 502, 602, the interfaces 104, 204, 304, 404, 504, 604, the sensing pins 206a/206b, 306a/306b, 406a/406b, 506a/506b, 606 (or more generally, the sensors 106), the orientation keys 110, 210, 310, 410, 510, 610, and the couplers 108, 208, 308, 408, 508, 608, respectively. Accordingly, portions and/or aspects of the trailer hitch assembly 700 that are similar in at least form and/or function to the corresponding portions and/or aspects of the trailer hitch assemblies 100, 200, 300, 400, 500, and/or 600 are not described in further detail herein. As described below, the trailer hitch assembly 700 further includes bracket bolts 703, coupler bolts 705, cover plates 707, and spacers 709.

The bracket 702 is configured to couple to a vehicle. The bracket 702 defines a C-shaped cross section that defines a channel between two protrusions. Each protrusion includes a central aperture that is configured to receive the sensing pin 706 and smaller apertures to receive the bracket bolts 703. The channel is configured to receive the interface 704 which includes apertures that are configured to align with the apertures of the bracket 702. The sensing pin 706 when disposed within the aperture, couple the bracket 702 to the interface 704 such that force transmits between the bracket 702 and the interface 704 via the sensing pin 706. The orientation key 710 is configured to engage slots in the sensing pin 706 to prevent the sensing pin 706 from rotating and/or falling out of the aperture during operation. The bracket bolts 703 provide further stability to prevent rotational forces from rotating the interface 704 relative to the bracket 702. The interface 704 is a tang that is configured to engage the channel of the bracket 702 as well as a channel defined by a proximal portion of the coupler 708. The interface 704 is further stabilized in the channel defined by bracket 702 by the spacers 709. The spacers 709 are configured to fit into the channel above and below the interface 704 so that the bracket 702 is stabilized vertically. The spacers 709 are held in place by two cover plates 707, which are attached to the spacers 709 and/or the bracket 702 via one or more fastener. The cover plates 707 are configured to receive forces in the vertical direction so that vertical loading forms are not transferred through the sensing pin 706. The cover plates 707 reduce compound loading (e.g., loading horizontally and vertically), which can decrease the probability of sensor error when the sensor is configured to measure horizontal forces. The interface 704 and the coupler 708 define additional apertures that are configured to allow for a fastener to fixedly couple the interface 704 to the coupler 708. The coupler 708 includes a portion that is configured to selectively couple to a ball hitch of a vehicle.

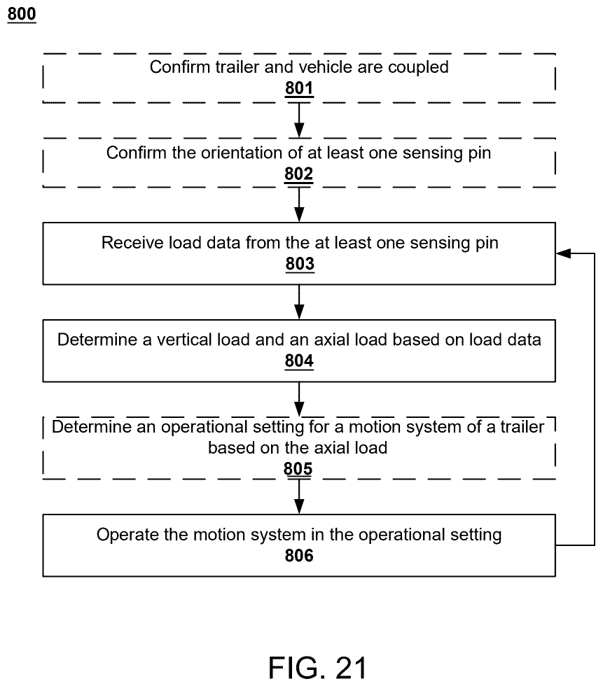

FIG. 21 depicts a flow chart of a method 800 for operating a motion system of a trailer, according to an embodiment. The method 800 can be implemented using any of the trailer hitch assemblies described herein (e.g., the trailer hitch assemblies 100, 200, 300, 400, 500, 600, and/or 700). The method 800 can be executed by a compute device, controller, and/or the like associated with a trailer (e.g., the trailer T) and/or a vehicle (e.g., the vehicle V) towing the trailer. In some embodiments, a user may activate a setting that indicates that a trailer is being towed that activates the method 800. In some embodiments, the method 800 can begin automatically based on one or more indication(s) (e.g., sensor signal, input, etc.) that a trailer is coupled to the vehicle. The method 800 includes optionally confirming that a trailer and a vehicle are coupled, at 801; optionally confirming an orientation of at least one sensing pin (e.g., functionally and/or structurally similar to any of the sensing pins 206a/206b, 306a/306b, 406a/406b, 506a/506b, 606, 706 (or more generally, the sensors 106), at 802; receiving load data from the at least one sensing pin, at 803; determining a vertical load and an axial load based on the load data, at 804; optionally determining an operational setting for a motion system of a trailer based on the axial load, at 805; and operating the motion system, such as a motor, engine, or brake can be operated in the operational setting, at 806.

The compute device, controller, etc. described herein can include a memory coupled to a processor. The processor can be, for example, a hardware based integrated circuit (IC), or any other suitable processing device configured to run and/or execute a set of instructions or code. For example, the processor can be a general-purpose processor, a central processing unit (CPU), an accelerated processing unit (APU), a microprocessor, a microcontroller, an application specific integrated circuit (ASIC), a field programmable gate array (FPGA), a programmable logic array (PLA), a complex programmable logic device (CPLD), a programmable logic controller (PLC), a processor board, a virtual processor, and/or the like. The underlying device technologies may be provided in a variety of component types such as metal-oxide semiconductor field-effect transistor (MOSFET) technologies like complementary metal-oxide semiconductor (CMOS), bipolar technologies like generative adversarial network (GAN), polymer technologies (e.g., silicon-conjugated polymer and metal-conjugated polymer-metal structures), mixed analog and digital technologies, and/or the like. The processor can be coupled to and/or in communication the memory through a system bus (for example, address bus, data bus and/or control bus).

The memory can be and/or can include one or more of a random-access memory (RAM)—inclusive of any type/subtype/generation of RAM (e.g., static RAM (SRAM), dynamic RAM (DRAM), double data rate RAM (DDRAM), synchronous dynamic RAM (SDRAM), etc.); a read-only memory (ROM)—inclusive of any type/subtype/generation of ROM (e.g., erasable programmable ROM (EPROM), electrically erasable programmable ROM (EEPROM), etc.); a memory buffer; a flash memory (e.g., NAND flash memory, etc.); and/or any other suitable volatile or non-volatile memory, combination(s) thereof, types or subtypes or variations thereof, generations thereof, and/or the like. The memory can be configured to store code, instructions, programs, applications, etc. that when executed cause the processor to perform or execute modules, processes, and/or functions associated with the electronic/compute device, such as sending/receiving data, aggregating data, analyzing data (e.g., received from one or more sources such as sensors, storage devices, processors, etc.), controlling any number of controllers, machines, devices, and/or components, and/or any other suitable processes, functions, routines, programs, applications, etc. In some implementations, the memory can include extendable storage units that can be added and used incrementally. In some implementations, the memory can be a portable memory (e.g., a flash drive, a portable hard disk, and/or the like) that can be operatively coupled to the processor. In some instances, the memory can be remotely operatively coupled with a compute device. For example, a remote database device can serve as a memory and be operatively coupled to the compute device.

At 801, the method 800 optionally includes confirming that the trailer and the vehicle are coupled. In some embodiments, confirming that the trailer and the vehicle are coupled can be based on a signal from the at least one sensing pin. For example, the at least one sensing pin can indicate that a load is detected as expected. In some embodiments, confirming that the trailer and the vehicle are coupled can be based on a sensor and/or the like included in a coupler that can indicate if the trailer and vehicle are coupled as desired. In some embodiments, confirming that the trailer and the vehicle are coupled can include confirming that the coupler is in a locked position. In some embodiments, if the trailer and the vehicle are coupled, a notification can be generated indicating coupling is confirmed. If coupling is not confirmed, a notification can be generated indicating coupling is not confirmed and, in some embodiments, an error indication corresponding to why coupling cannot be confirmed.

At 802, the method 800 optionally includes confirming the orientation of at least one sensing pin. For example, confirming the orientation of the at least one sensing pin can include determining if a correct sensing pin is in an associated location. For example, if a top pin is in a top position and a bottom pin is in a bottom position. As another example, confirming the orientation can include determining if the at least one sensing pin is rotated in a desired position and/or if an orientation key is engaged. In some embodiments, if the orientation of the at least one sensing pin is confirmed, a notification can be generated that indicates that the at least one sensing pin is correctly oriented. In some embodiments, if the orientation is not confirmed, a notification can be generated that indicates which sensing pin of the sensing pins is not oriented as desired.

At 803, the method 800 includes receiving load data from the at least one sensing pin. The load data can be associated with the axial loads (e.g., towing loads) and vertical loads (e.g., hitch loads) associated with the operation of towing the trailer with the vehicle. In some embodiments, the load data associated with the axial loads and/or vertical loads is measured simultaneously by the at least one sensing pin. In some embodiments, the load data can include characteristics such as strain data, force data, moment data (e.g., moment of force (“torque”) data, and/or the like.

At 804, the method 800 includes determining a vertical load and/or an axial load based on load data. In some embodiments, calculating the vertical load and/or the axial load can be based on the moments and/or torque in the load data. In some embodiments, determining the vertical load and the axial load can be based on one or more characteristics associated with the load data. In some embodiments, after the vertical load has been determined, 804 can include determining the tongue weight of the trailer and comparing the tongue weight to a weight threshold. The weight threshold can be associated with a safe operating threshold for the trailer. If the tongue weight is determined to be greater than the weight threshold, an alert can be generated that indicates that the tongue weight is greater than the weight threshold.

At 805, the method 800 optionally includes determining an operational setting for a motion system of a trailer based on the axial load. In some embodiments, the motion system can be a propulsion system, motor system, an engine system, a braking system, an energy recovery system, and/or the like. For example, the operational setting can include operating a trailer propulsion system (e.g., engine, motor, etc.) to control propulsion system torque based on the axial load. As another example, the operational setting can include determining a braking setting such as anti-lock braking, regenerative braking, and/or the like based on the vertical loads and/or the axial loads. In this way the vehicle's motion system can be augmented by a motion system of the trailer based on an axial and/or vertical load. Thus, the operation of the vehicle-trailer combination can be automatically coordinated in response to dynamic conditions, such as vehicle maneuvers, terrain, road condition, etc. In some embodiments, the operational setting can correspond to at least one wheel of the trailer. At 806, the method 800 includes operating the motion system in the operational setting. After 806, the method 800 returns to 803 and the method 800 continues from there. The method 800 can repeat until the vehicle and/or the trailer are uncoupled.

The specific terminology used herein is for the purpose of describing particular embodiments and/or features or components thereof and is not intended to be limiting. While various schematics, embodiments, and/or implementations have been described above, it should be understood that they have been presented by way of example only, and not limitation. Various modifications, changes, and/or variations in form and/or detail may be made without departing from the scope and/or spirit of the disclosure and/or without altering the function and/or advantages thereof unless expressly stated otherwise.

For example, some embodiments describe various hardware components, such as brackets, interfaces, and couplers being matingly coupled via various configurations (e.g., tangs, c-shaped structures, etc.). It should be understood that such components can embody or can be coupled using any suitable geometry. For example, where an embodiment describes a bracket having a C-shaped that is configured to receive a tang (e.g., second portion) of the interface and/or the bracket, it should be understood that this geometry could be reversed such that a C-shaped interface portion is configured to receive a tang of a bracket. Many additional changes in the details, materials, and arrangement of parts, herein described and illustrated, may be made by those skilled in the art.

Likewise, while embodiments (and/or features, components, configurations, aspects, etc. thereof) may be described above in the context of certain implementations, it should be understood that such implementations are presented by way of example only, and not limitation. Any of the embodiments (and/or features, components, configurations, aspects, etc. thereof) can be used in, and/or adapted for use in, other implementations unless expressly stated otherwise. Functionally equivalent embodiments, implementations, and/or methods, in addition to those described herein, will be apparent to those skilled in the art from the foregoing descriptions and are intended to fall within the scope and/or spirit of the disclosure.

Where schematics, embodiments, and/or implementations described above indicate certain components arranged in certain orientations, configurations, or positions, the arrangement of components may be modified. Although various embodiments have been described as having particular features, configurations, and/or combinations of components, other embodiments are possible having a combination of any features, configurations, and/or components from any of embodiments described herein, except mutually exclusive combinations. The embodiments described herein can include various combinations and/or sub-combinations of the functions, components, configurations, and/or features of the different embodiments described.

The specific configurations of the various components can also be varied. For example, the size and specific shape of the various components can be different from the embodiments shown, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Throughout the entirety of the present disclosure, use of the articles “a,” “an,” and/or “the” to modify a noun may be understood to be used for convenience and to include one, or more than one, of the modified noun, unless otherwise specifically stated. Any reference herein to a singular component, feature, aspect, etc. is not intended to imply the exclusion of more than one such component, feature, aspect, etc. (and/or vice versa) unless expressly stated otherwise. The terms “comprising,” “including,” “having,” and/or the like are intended to be inclusive and mean that there may be additional elements other than the listed elements. Thus, reference to specific elements, features, aspects, characteristics, etc. does not preclude the presence or addition of one or more other elements, features, aspects, characteristics, etc. unless such combinations are mutually exclusive or otherwise specifically stated.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. As used herein, in particular embodiments, the terms “about” or “approximately,” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals.

The term “processor” should be interpreted broadly to encompass a general-purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC), and/or the like. Software modules (executed on hardware) can be expressed in a variety of software languages (e.g., computer code), including C, C++, Java™, Ruby, Visual Basic™, Python™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.), or other suitable programming languages, development tools, and/or combinations thereof (e.g., Python™). Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

What is claimed is:

1. An apparatus, comprising:
a coupler configured to couple to a hitch of a tow vehicle;
a bracket configured to couple to a body of the trailer; and
a sensor disposed at an interface of the coupler and the bracket and configured to measure an axial force and a vertical force at the interface.

2. The apparatus of claim 1, further comprising:
an orientation key configured to orient the sensor when aligned with a keying feature on the sensor.

3. The apparatus of claim 1, further comprising:
the interface, wherein the bracket is coupled to a first portion of the interface and the coupler is coupled to a second portion of the interface.

4. The apparatus of claim 3, wherein the bracket defines a protrusion configured to be disposed in the first portion of the interface.

5. The apparatus of claim 3, wherein the sensor comprises a sensing pin, the sensing pin disposed in a set of apertures defined by the first portion of the bracket and a set of apertures defined by the first portion of the interface.

6. The apparatus of claim 5, wherein the sensing pin forms a load path between the bracket and the interface, the sensing pin configured to measure the axial force and the vertical force along the load path.

7. An apparatus, comprising:
a coupler configured to couple to a hitch of a tow vehicle;
a bracket configured to couple to a body of the trailer;
an interface coupled between the coupler and the bracket; and
a sensing pin coupling the interface to the bracket, the sensing pin forming a load path between the interface and the bracket such that the sensing pin measures an axial force and a vertical force at the interface.

8. The apparatus of claim 7, further comprising:
an orientation key coupled to the interface and engaged with a keying feature of the sensing pin on the at least one sensor.

9. The apparatus of claim 7, wherein the sensing pin is a first sensing pin, the apparatus further comprising:
a second sensing pin, the first sensing pin and the second sensing pin collectively coupling the interface to the bracket, the first sensing pin and the second sensing pin collectively forming the load path between the interface and the bracket such that each of the first sensing pin and the second sensing pin measures the axial force and the vertical force at the interface.

10. The apparatus of claim 7, wherein the bracket defines a protrusion configured to be disposed in a first portion of the interface.

11. The apparatus of claim 10, wherein the first portion of the interface defines a first aperture and the protrusion of the bracket defines a second aperture, the protrusion of the bracket being disposed in the first portion of the interface such that the first aperture is aligned with the second aperture.

12. The apparatus of claim 11, wherein at least a portion of the sensing pin extends through the first aperture and the second aperture to couple the interface to the bracket.

13. The apparatus of claim 12, wherein the load path is a first load path, the protrusion of the bracket is sized and shaped to be disposed in the first portion of the interface without forming a second load path associated with contact between the protrusion and the first portion of the interface.

14. The apparatus of claim 7, wherein a first portion of the coupler is configured to couple to the hitch of the tow vehicle and a second portion of the coupler is configured to be disposed in a second portion of the interface.

15. The apparatus of claim 14, wherein the second portion of the coupler is rigidly coupled to the second portion of the interface.

16. A method for operating a motion system of a trailer, the method comprising:
receiving load data from at least one sensing pin disposed at an interface between the trailer and a tow vehicle;
determining, based on the load data, a vertical load and an axial load associated with the tow vehicle towing the trailer; and
operating a motion system of the trailer based on at least one of the vertical load or the axial load.

17. The method of claim 16, wherein a first portion of the interface is coupled to a bracket that is coupled to a trailer and a second portion of the interface is coupled to a coupler that is coupled to a hitch of the tow vehicle, the at least one sensing pin coupling the interface to the bracket such that the sensing pin forms a load path therebetween.

18. The method of claim 16, further comprising:
determining, based at least in part on the load data, if the trailer and the tow vehicle are coupled.

19. The method of claim 16, further comprising:
confirming an orientation of the at least one sensing pin; and
generating a notification that the at least one sensing pin is in a predetermined orientation.

20. The method of claim 16, further comprising:
calculating, based at least in part on the vertical load, a moment of force exerted on the interface; and
determining, based on the moment of force exerted on the interface, a load associated with the trailer.
